(19) United States
(12) Patent Application Publication
(10) Pub. No.: US 2023/0227148 A1
(43) Pub. Date: Jul. 20, 2023

(54) Servo Drive Vernier Control

(71) Applicant: Textron Aviation Inc., Wichita, KS (US)

(72) Inventor: Matthew James Anker, Benton, KS (US)

(21) Appl. No.: 18/155,036

(22) Filed: Jan. 16, 2023

Related U.S. Application Data
(60) Provisional application No. 63/301,301, filed on Jan. 20, 2022.

(51) Int. Cl. B64C 13/50

(52) U.S. Cl. CPC B64C 13/50

(57) ABSTRACT

A servo drive vernier control for aircraft having a push-pull mechanism configured for manual actuation by a user includes a push rod mechanically coupled with an input knob. The push rod is configured for manual actuation via the input knob. An electromechanical control system is operatively coupled with the push rod for providing automated operation of the push rod. The electromechanical system includes a motor operatively coupled to the push rod. The motor is configured to rotate the push rod for actuating the push-pull mechanism. A controller is communicatively coupled to the motor for enabling electronic control of the push-pull mechanism.

### CROSS-REFERENCE TO RELATED APPLICATIONS

This application claims the benefit of priority of U.S. Provisional Patent Application No. 63/301,301 entitled “Servo Drive Vernier Control”, and filed on Jan. 20, 2022, the disclosure of which is herein incorporated by reference in its entirety.

### BACKGROUND OF THE INVENTION

1. Field

The disclosed embodiments relate generally to aircraft control systems. More specifically, the embodiments relate to control systems for reciprocating aircraft engines.

### 2. Description of the Related Art

Different types of push-pull control are known. For example, U.S. Pat. No. 8,485,057 to McFarlane et al. discloses a prior art standard vernier control that accepts push-pull and rotational input to provide longitudinal output. U.S. Pat. No. 5,103,125 to Ogden discloses an electronic control adapter having a potentiometer for mechanical throttle control of an engine. U.S. Pat. No. 8,972,084 to Bissontz describes a control system having a remote vernier throttle for use with a vehicle having a hybrid-electric powertrain.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In an embodiment, a servo drive vernier control for aircraft having a push-pull mechanism configured for manual actuation by a user includes a push rod mechanically coupled with an input knob. The push rod is configured for manual actuation via the input knob. An electromechanical control system is operatively coupled with the push rod for providing automated operation of the push rod. The electromechanical system includes a motor operatively coupled to the push rod. The motor is configured to rotate the push rod for actuating the push-pull mechanism. A controller is communicatively coupled to motor for enabling electronic control of the push-pull mechanism.

In another embodiment, a servo drive vernier control for aircraft having a push-pull mechanism includes a push rod configured to provide manual actuation of the push-pull mechanism by a user. The push rod includes a flatted section having flat portions on opposite sides of the push rod. A motor is operatively coupled to the push rod at the flatted section. The motor is configured to rotate the push rod for actuating the push-pull mechanism. A controller is communicatively coupled to motor for enabling electronic control of the push-pull mechanism.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 illustrates a perspective view of a prior art Vernier control for some embodiments;

FIG. 2 illustrates a cross-sectional view of a servo drive vernier control for some embodiments;

FIG. 3A illustrates a first sectional view of a push rod of the servo drive vernier control engaged with associated driven gear for some embodiments; and

FIG. 3B illustrates a second sectional view of the push rod for some embodiments.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Reciprocating aircraft engines lack electronic engine controls. As such, aircraft throttle, propeller, and mixture are manually set by the pilot. Reciprocating aircraft engines often rely upon push-pull mechanisms, such as a vernier control, to set aircraft throttle, propeller, and mixture. Due to the lack of electronic engine controls, technologies such as autothrottle and autoland are unavailable in conventional piston engine aircraft.

Embodiments disclosed herein are generally related to a control system to enable electronic control of manual push-pull controls used to control throttle, propeller, and mixture in piston engine aircraft. A push-pull mechanism may be configured to translate rotational input received at an input knob from a pilot into linear movement. The push-pull control mechanism may be outfitted with a push rod having a flatted shaft profile in a body of said mechanism. An input knob may be rotated or translated to move the push rod. A control system for the push-pull mechanism may comprise a gear pair powered by a motor. A driven gear in the gear pair may be shaped to fit about the flatted shaft profile. When the driven gear is powered, the driven gear may rotate the flatted shaft providing substantially the same input as if the input knob of the push-pull mechanism was manually actuated by the pilot. By providing electronic control of the push-pull control mechanism, automatic flight control mechanisms may be enabled for reciprocating engines.

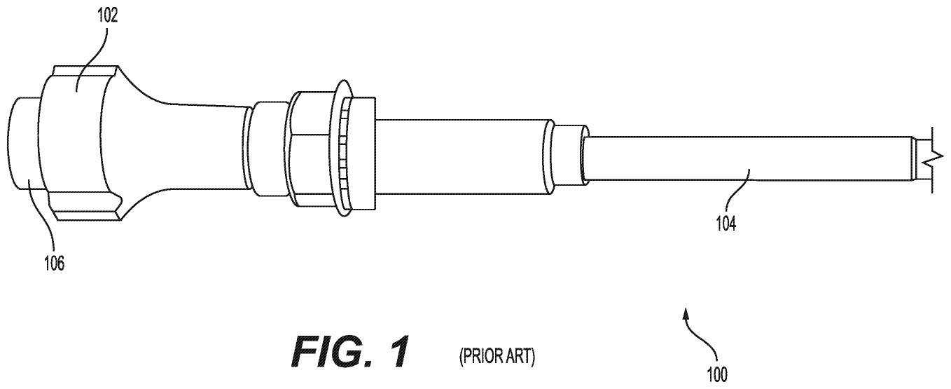

FIG. 1 illustrates a prior art push-pull control 100. Push-pull control 100 may be a Vernier control typically found in piston engine aircraft used to control propellor, mixture, and throttle as described above. Push-pull control 100 may receive rotational input from a user at knob 102 that allows for the user to finely control the movement of a push rod 104. A button 106 may be provided that can switch push-pull control 100 from accepting rotational input to accepting linear input. The linear input may allow for coarser adjustments to the output to be made. Due to push-pull control 100 only accepting manual inputs, automated flight technologies, such as autothrottle, are incompatible with push-pull control 100.

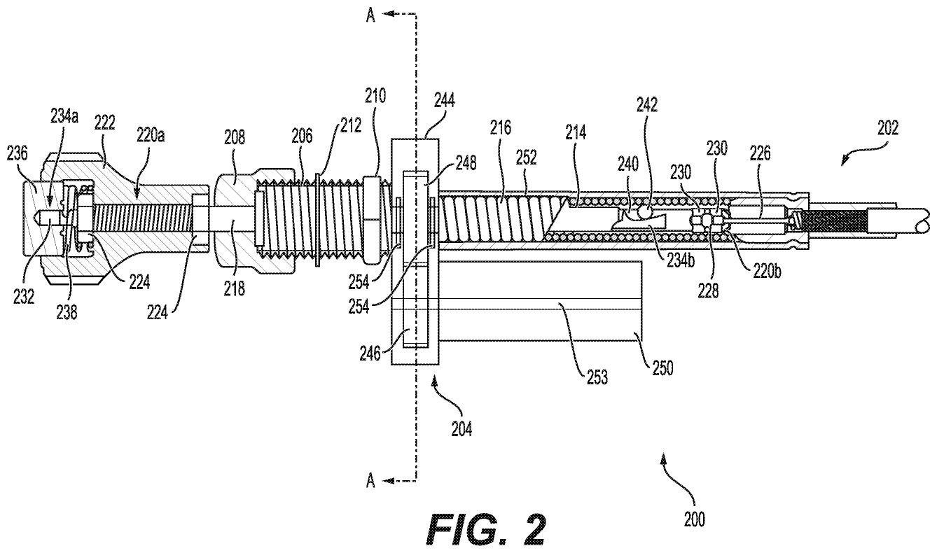

FIG. 2 illustrates a servo drive vernier control 200 for some embodiments. Servo drive vernier control 200 may comprise a push-pull mechanism 202 and an electromechanical control system 204. Push-pull mechanism 202 may be substantially similar to a push-pull control 100 of FIG. 1. The push-pull mechanism 202 may convert rotational input received from a user to a linear output to allow for fine adjustments of throttle, propeller, or mixture. For coarser adjustments, the push-pull mechanism 202 may be configured to receive push/pull actuation by a user. Electromechanical control system 204 may provide electronic control of push-pull mechanism 202 such that push-pull mechanism 202 may be controlled by an automatic flight control system, electronic engine control, or other similar control systems.

Push-pull mechanism 202 may comprise a tube 206. In some embodiments, tube 206 is threaded as shown. Tube 206 may be coupled (e.g., threadedly coupled) to a first nut 208 and a second nut 210. In some embodiments, first nut 208 is a panel nut. Tube 206, first nut 208, and second nut 210 may be fixed to a stationary element (not shown), such as an instrument panel or other housing, by sandwiching the stationary element between the first nut 208 and the second nut 210. In some embodiments, push-pull mechanism 202 comprises a washer 212. In some embodiments, washer 212 is a lock washer configured to substantially prevent rotational movement of tube 206. Tube 206 may be substantially hollow. A helical surface 214 may extend along an inside surface of tube 206. In some embodiments, the helical surface 214 is formed by a spring 216.

A push rod 218 having a proximal end 220a and a distal end 220b may extend through first nut 208 and inside tube 206. An input knob 222 may be coupled to proximal end 220a. In some embodiments, input knob 222 is coupled to proximal end 220a via nuts 224. Input knob 222 is configured to receive push/pull actuation by a user's fingers/hand. Pushing or pulling input knob 222 longitudinally (e.g., along a longitudinal axis of push rod 218) enables coarse adjustment of push rod 218. A cable 226 having a cable end 228 may be coupled to distal end 220b via one or more bearings 230 surrounding cable end 228. Cable 226 is for example a flexible cable configured to transmit linear motion from push rod 218 for actuating pilot controls. In some embodiments, cable 226 is about 30 to 60 inches in length and sheathed inside a flexible cable housing that passes through the aircraft firewall. Cable 226 may be mechanically coupled to lever controls for a throttle body, a mixture valve, and/or a propeller governor, in embodiments.

A release shaft 232 having a proximal end 234a and a distal end 234b may extend inside push rod 218. A button 236 may be coupled to proximal end 234a. A spring 238 may bias button 236 and release shaft 232 in an extended configuration. In the extended configuration, push rod may be rotated but not pushed. Specifically, distal end 234b may be substantially wedge-shaped, thereby forming a cavity 240. A ball 242 may be positioned in cavity 240. When button 236 and release shaft 232 are biased to the extended configuration, distal end 234b may force ball 242 to interact with helical surface 214 (i.e., spring 216), thereby prohibiting push rod 218 from being moved longitudinally relative to tube 206 and first nut 208. Ball 242 may travel along helical surface 214; as such, input knob 222 may be rotated, causing push rod 218 to move longitudinally relative to tube 206 and first nut 208. Based in part on the incline in helical surface 214, fine rotations of input knob 222 provide fine inward or outward movement of push rod 218.

As described above, spring 238 may bias release shaft 232 and ball 242 in the extended configuration. Actuation of button 236 may overcome the biasing force in spring 238, and release shaft 232 and ball 242 may no longer be in the extended configuration. In the non-extended configuration, push rod may be pushed but not rotated. Specifically, upon actuation of button 236, ball 242 may disengage from helical surface 214, and push rod 218 may be pushed or pulled relative to tube 206 and first nut 208. As such, input knob 222 may now be operable to receive longitudinal input thereto. The longitudinal input may cause a substantially larger displacement of push rod 218 than provided by the rotation of input knob 222 when push-pull mechanism 202 operates in the extended configuration. When out of the extended configuration, push-pull mechanism 202 may not be operable to receive rotational input because ball 242 is no longer engaged with helical surface 214. Since the vernier controls need only a minimal torque to operate, when a user pushes button 236, which is accomplished by grasping the input knob 222, rotational motion is mechanically stopped because the motor does not have adequate torque to override the manual input. Alternatively, electronic or mechanical clutching may be provided to satisfy a system safety condition for loss of powerplant control.

Electromechanical control system 204 may comprise a gear housing 244, a drive gear 246, a driven gear 248, and a motor 250. Drive gear 246 may be meshed with driven gear 248. Gear housing 244 may be disposed between tube 206 and an outer housing 252 of push-pull mechanism 202. In some embodiments, gear housing 244 comprises aluminum, cast iron, composites, or the like. Motor 250 may be mounted to gear housing 244. In embodiments, motor 250 is a servo motor configured with a sensor that provides position feedback and communicatively coupled with a controller for providing precise rotary control of the motor. In some embodiments, motor 250 is a substantially low-torque motor such that motor 250 may be easily stopped if needed. In some embodiments, motor 250 is a DC brushless motor. Motor 250 may comprise a slip clutch or other similar braking method to limit the torque therefrom. Additionally, or alternatively, the user may manually brake motor 250 by preventing the rotation of input knob 222.

In embodiments having a controller, the controller may comprise a dedicated motor controller, a microcontroller, a microprocessor, a programmable logic controller (PLC), and/or a computer (e.g., an aircraft flight computer or separate computer). The controller may comprise a memory, including a non-transitory computer-readable medium for storing software, and a processor for executing instructions of the software, as known to one of skill in the art. In certain embodiments, some, or all of software is configured as firmware for providing low-level control of motor 250. In embodiments, a position sensor may be used for determining a position of motor 250 and providing position feedback to the controller.

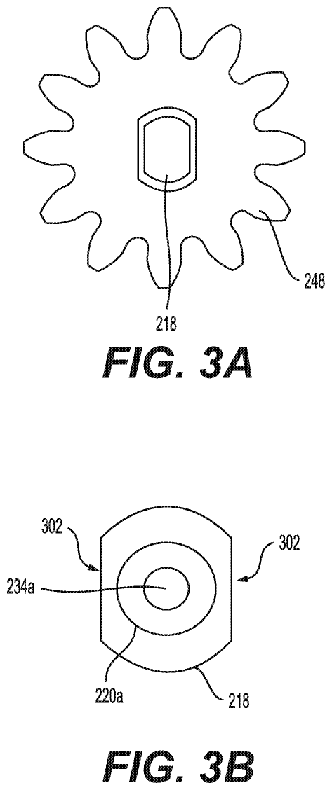

When actuated, motor 250 may drive the drive gear 246 via drive shaft 253. In some embodiments, drive gear 246 is driven directly by drive shaft 253. Alternatively, or additionally, additional gears may be present between drive shaft 253 and drive gear 246 to increase/decrease the power received from drive shaft 253. Drive gear 246 may drive driven gear 248. In some embodiments, driven gear 248 is sandwiched between spacers 254. Driven gear 248 and spacers 254 may be disposed circumferentially around push rod 218. Driven gear 248 may interface with push rod 218 such that, as driven gear 248 rotates, driven gear 248 may rotate push rod 218. As such, driven gear 248 may actuate push rod 218 as if input knob 222 were manually rotated by the pilot. As previously described, when push-pull mechanism 202 operates in the extended configuration, ball 242 may engage with helical surface 214 such that rotational motion of push rod 218, as caused by driven gear 248, may result in substantially fine longitudinal translation of push rod 218. In some embodiments, push rod 218 comprises a flatted profile (see FIGS. 3A & 3B) to promote rotation via driven gear 248. In some embodiments, gears 246, 248 comprise a substantially soft plastic, such as nylon, to aid in slipping along push rod 218.

Electromechanical control system 204 may provide electronic control of push-pull mechanism 202 such that automated technologies including autothrottle and/or autoland may be enabled as described above. For example, electromechanical control system 204 may allow for engine start to be initiated, setting of propeller speed (RPM), setting of full mixture, setting mixture to cutoff, or a combination thereof. In embodiments, the controller of electromechanical control system 204 comprises a user interface configured to enable a pilot/co-pilot to input target values (e.g., values for throttle, propeller, or mixture) for electromechanical control system 204 to adhere to. The controller then determines an adjustment to push-pull mechanism 202 via motor 250 based on one or more input target values. The controller may receive data from various sensors used onboard the aircraft (e.g., sensors to monitor the throttle, propeller, and mixture), and the controller may regulate motor 250 based on the data received from the various sensors. For example, a tachometer may monitor propeller RPM and provide sensed RPM values to the controller, which may be used to adjust the torque of motor 250 to match a target RPM value. In some embodiments, electromechanical control system 204 powers push-pull mechanism 202 while operating in the extended configuration, and servo drive vernier control 200 is configured for manual input of input knob 222 to be received when push-pull mechanism 202 is not operating in the extended configuration.

FIGS. 3A and 3B illustrate views of push rod 218 for some embodiments. FIG. 3A illustrates a sectional view along the line A-A as illustrated in FIG. 2, and FIG. 3B illustrates an end view from the left end illustrated in FIG. 2. As described above and illustrated in FIG. 3A, driven gear 248 may be disposed on an outer surface of push rod 218. When driven by drive gear 246, driven gear 248 may cause the rotation of push rod 218 for push-pull mechanism 202.

Push rod 218 is configured to slide longitudinally within driven gear 248 such that manual actuation via the input knob 222 may proceed. In some embodiments, push rod 218 comprises steel, aluminum, or other like materials that provide a substantially smooth moving surface for driven gear 248 to slide along. In some embodiments, push rod 218 comprises a coating (e.g., chrome) to reduce friction. Push rod 218 may comprise a substantially flatted shaft section having flat portions 302 on opposite sides of push rod 218, as shown in FIG. 3B. The flatted shaft section is configured to match the internal opening of driven gear 248 for rotating push rod 218 via motor 250. Driven gear 248 may rotate about a longitudinal axis of servo drive vernier control 200.

While embodiments have been described herein with respect to a Vernier-type push-pull mechanism 202, it should be noted that electromechanical control system 204 is not limited to this specific push-pull control mechanism, and electromechanical control system 204 may be suitably modified to adapt to other linear control mechanisms. Further, embodiments are not meant to be limiting to use in aircraft controls, and the servo drive vernier control 200 may be used in any industry that utilizes such linear control mechanisms.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A servo drive vernier control for aircraft having a push-pull mechanism configured for manual actuation by a user, the servo drive vernier control comprising:
a push rod mechanically coupled with an input knob, wherein the push rod is configured for manual actuation via the input knob; and
an electromechanical control system operatively coupled with the push rod for providing automated operation of the push rod, the electromechanical system comprising:
a motor operatively coupled to the push rod, wherein the motor is configured to rotate the push rod for actuating the push-pull mechanism; and
a controller communicatively coupled to motor for enabling electronic control of the push-pull mechanism.

2. The servo drive vernier control of claim 1, comprising a first gear disposed on the push rod and a second gear operatively coupled to the motor, wherein the second gear is configured for driving the first gear for actuating the push-pull mechanism.

3. The servo drive vernier control of claim 1, comprising a position sensor operative coupled to the motor, wherein the position sensor provides position feedback to the controller.

4. The servo drive vernier control of claim 1, comprising a substantially low-torque motor such that the motor may be easily stopped by a user holding the input knob.

5. The servo drive vernier control of claim 1, wherein the motor comprises a DC brushless motor.

6. The servo drive vernier control of claim 1, wherein the motor comprises a slip clutch configured to limit torque provided by the motor.

7. The servo drive vernier control of claim 2, comprising a pair of spacers disposed about the push rod on opposite sides of the first gear, wherein the first gear is disposed circumferentially around the push rod.

8. The servo drive vernier control of claim 2, wherein the first gear comprises a substantially soft plastic configured to aid in sliding of the first gear on the push rod.

9. The servo drive vernier control of claim 2, wherein the push rod comprises a flatted section having flat portions on opposite sides of the push rod, and the first gear has matching flat portions configured to assist with rotation of the push rod.

10. The servo drive vernier control of claim 1, wherein the controller is configured to perform one or more of initiating engine start, setting of propeller speed, setting of full mixture, setting mixture to cutoff, and combinations thereof.

11. The servo drive vernier control of claim 1, comprising a user interface communicatively coupled with the controller, wherein the user interface is configured to receive input for setting a target value, and the controller determines an adjustment to the push-pull mechanism via the motor based on the target value.

12. The servo drive vernier control of claim 1, comprising a release button configured to enable manual actuation of the push rod via the input button without use of the motor.

13. A servo drive vernier control for aircraft having a push-pull mechanism, the servo drive vernier control comprising:
a push rod configured to provide manual actuation of the push-pull mechanism by a user, wherein the push rod comprises a flatted section having flat portions on opposite sides of the push rod;
a motor operatively coupled to the push rod at the flatted section, wherein the motor is configured to rotate the push rod for actuating the push-pull mechanism; and
a controller communicatively coupled to motor for enabling electronic control of the push-pull mechanism.

14. The servo drive vernier control of claim 13, comprising a first gear disposed around the push rod and a second gear operatively coupled to the motor, wherein the first gear comprises flat portions configured to align with the flat portions of the push rod for assisting with rotation of the push rod.

15. The servo drive vernier control of claim 14, wherein the push rod comprises a chrome surface configured to promote slipping of the first gear along the push rod thereby enabling manual activation of the push rod.

16. The servo drive vernier control of claim 14, wherein the first gear is comprised of a nylon plastic configured to promote slipping of the first gear along the push rod thereby enabling manual activation of the push rod.

17. The servo drive vernier control of claim 13, wherein the controller is configured to perform one or more of initiating engine start, setting of propeller speed, setting of full mixture, setting mixture to cutoff, and combinations thereof

18. The servo drive vernier control of claim 13, comprising a user interface communicatively coupled with the controller, wherein the user interface is configured to receive input for setting a target value, and the controller determines an adjustment to the push-pull mechanism via the motor based on the target value.

19. The servo drive vernier control of claim 13, comprising a release button configured to enable manual actuation of the push rod longitudinally and to disable rotational actuation of the push rod.

20. The servo drive vernier control of claim 13, wherein the push rod is mechanically coupled to a flexible cable configured to transmit linear motion from the push rod for actuating lever controls of one or more of a throttle body, a mixture valve, a propeller governor, and combinations thereof.
